(19) United States
(12) Patent Application Publication
(10) Pub. No.: US 2013/0343056 A1
(43) Pub. Date: Dec. 26, 2013

(54) High-Power Light Emitting Diode Illumination System

(71) Applicant: LED North America, Oak Ridge, TN (US)

(72) Inventor: Andrew J. Wilhelm, Knoxville, TN (US)

(21) Appl. No.: 13/867,448

(22) Filed: Apr. 22, 2013

Related U.S. Application Data
(60) Provisional application No. 61/663,260, filed on Jun. 22, 2012.

(51) Int. Cl. F21V 29/00

(52) U.S. Cl. CPC F21V 29/22
USPC 362/249.02

(57) ABSTRACT

Disclosed herein are systems for removing heat from LED illumination equipment. Such systems typically include a heat dissipater formed as a monolithic box-shaped structure having six faces, with no protuberances extending from any of the six faces. The heat dissipater may be fabricated from carbon foam. Some embodiments include a heat sink, and holes are drilled through the system to provide convection cooling.

### CROSS-REFERENCE(S) TO RELATED APPLICATION(S)

This application claims all right and benefit of U.S. Provisional Application No. 61/663,260, filed Jun. 22, 2012.

### FIELD

This disclosure relates to the field of light emitting diode (LED) systems. More particularly, this disclosure relates to systems for dissipating thermal energy generated by an LED illumination system.

### BACKGROUND

Light emitting diodes (LEDs) provide a generally efficient means for generating light from electricity. However, as the power consumption of an LED increases, the thermal energy generated also increases. The increased thermal energy may damage the LED or its associated adjacent circuitry. What are needed therefore are improved mechanisms for dissipating the thermal energy generated by an LED illumination system.

### SUMMARY

The present disclosure provides an illumination system that has a circuit board having an electrically conductive pattern and having a first circuit board side and an opposing second circuit board side. There is at least one light emitting diode disposed on the first circuit board side. When each light emitting diode is energized through the electrically conductive pattern and generates a minimum steady state thermal output of at least 50 watt-thermal. Further provided in most embodiments is a heat dissipater having a first heat dissipater side disposed adjacent the second circuit board side and an opposing second heat dissipater side. Typically the thermal conductivity between the first circuit board side and the second heat dissipater side is at least 0.3 watts per meter Kelvin. In some embodiments the heat dissipater has a sufficient thickness that at the maximum steady state thermal output of the at least one light emitting diode, without a heat sink disposed adjacent the second heat dissipater side, a thermal gradient from a hottest temperature to a coolest temperature on the second heat dissipater side is less than 50 K/cm. In some embodiments the heat dissipater has a sufficient thickness that at the maximum steady state thermal output of the at least one light emitting diode, without a heat sink disposed adjacent the second heat dissipater side, a thermal gradient from a hottest temperature to a coolest temperature on the second heat dissipater side is less than 50 K/cm. In some embodiments the heat dissipater has a sufficient thickness that at the maximum steady state thermal output of the at least one light emitting diode, without a heat sink disposed adjacent the second heat dissipater side, a temperature measured in Kelvin at any first point adjoining the at least one light emitting diode is reduced by at least 10% at second point opposite the first point on the second heat dissipater side.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a plan view of a circuit board with a plurality of LEDs affixed thereto;

FIG. 2 is a plan view of a thermal dissipater;

FIG. 3 is a side view of an LED illumination system;

FIG. 4 is a plan view of a heat sink for use in an LED illumination system;

FIG. 5 is a perspective view of an LED illumination system view from the bottom; and

FIG. 6. is a perspective view an LED illumination system viewed from the top.

### DETAILED DESCRIPTION

In the following detailed description of the preferred and other embodiments, reference is made to the accompanying drawings, which form a part hereof, and within which are shown by way of illustration the practice of specific embodiments of an illumination system. It is to be understood that other embodiments may be utilized, and that structural changes may be made and processes may vary in other embodiments.

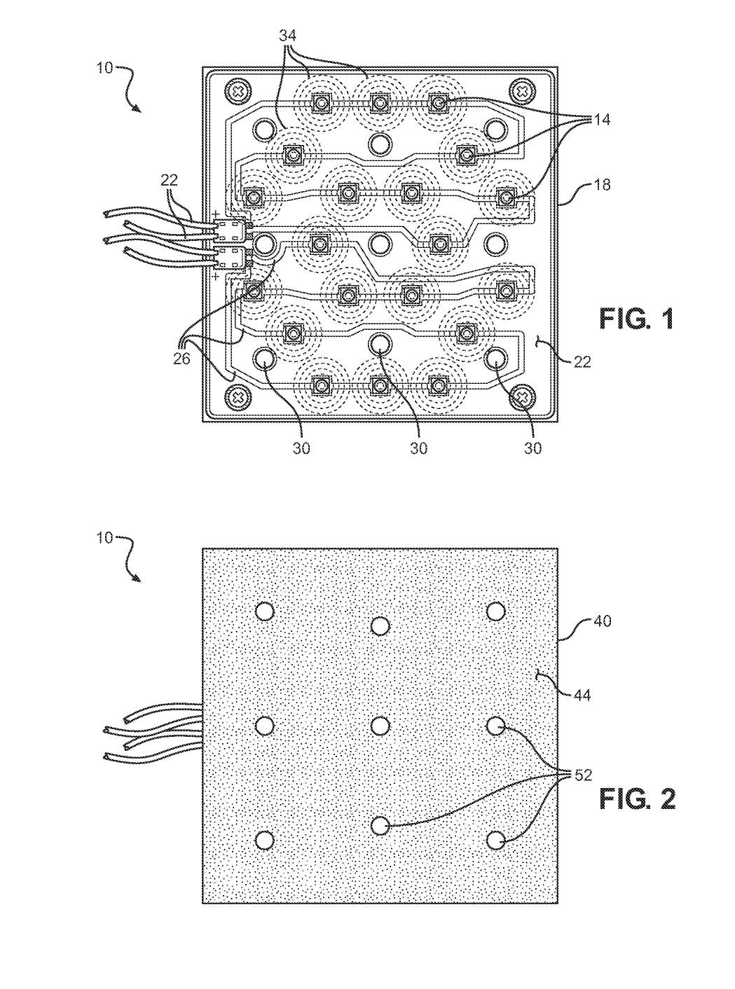

FIG. 1 illustrates certain components for use in an illumination system 10. The illumination system 10 includes a plurality of light emitting diodes (LEDs) 14 mounted on a circuit board 18. The LEDs 14 are mounted on a first circuit board side 22 of the circuit board 18. A power connector system 24 energizes the LEDs 14 through an electrically conductive pattern 26 on the first circuit board side 22. The circuit board 18 has a plurality of circuit board holes 30 through the circuit board 18. In operation, the first circuit board side 22 heats up, with higher temperatures being at locations corresponding to the locations of the LEDs 14 on the circuit board 18. Thermal isobars 34 are depicted, and the isobars 34 indicate thermal gradients on the first circuit board side 22.

FIG. 2 illustrates a heat dissipater 40. As the term is used herein, a “heat dissipater” is a monolithic box-shaped structure having six faces, with no protuberances extending from any of the six faces. In the embodiment of FIG. 2 the heat dissipater 40 is a carbon foam material. The heat dissipater 40 has a first heat dissipater side 44 and the heat dissipater 40 has a plurality of heat dissipater holes 52 through the heat dissipater 40.

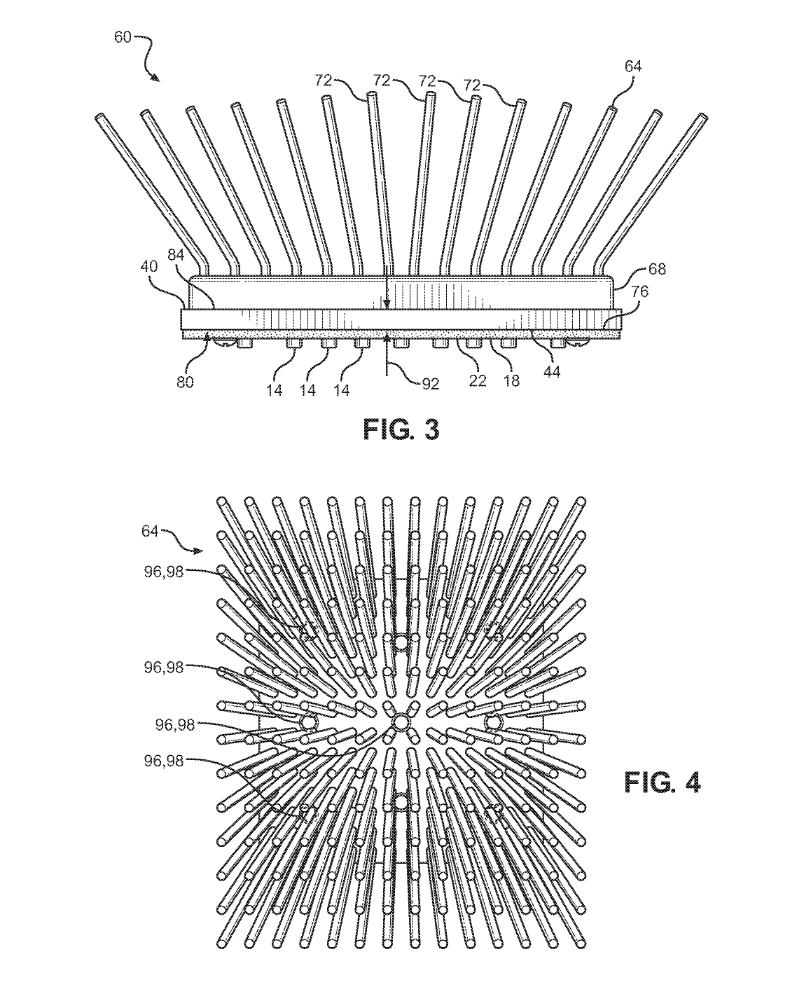

FIG. 3 illustrates an illumination system 60. The illumination system 60 includes the LEDS 14, the circuit board 18, the power connector system 24, and the heat dissipater 40 used in the illumination system 10 depicted in FIGS. 1 and 2. The illumination system 60 further includes a heat sink 64. As used herein, a “heat sink” is a device formed with a monolithic box-shaped structure having six faces (such as a monolithic box-shaped structure 68 depicted in FIG. 3), plus a plurality of protuberances extending from at least one of the faces (such a plurality of protuberances 72 depicted in FIG. 3). While the protuberances 72 depicted in FIG. 3 are cylindrical rods, in other embodiments protuberances may be square rods, or may be pins, or may be fins, or may be vanes, or similar structures. FIG. 3 illustrates that the circuit board 18 has a second circuit board side 76 opposing the first circuit board side 22. Also the heat dissipater 40 has a second heat dissipater side 84 opposing the first heat dissipater side 44. The heat sink 64 has a first heat sink side 88. The first heat dissipater side 44 is disposed adjacent the second circuit board side 76. The second heat dissipater side 84 is disposed adjacent the first heat sink side 88. In some embodiments a thermal heat transfer material (such as a paste or an adhesive) may be disposed between the first heat dissipater side 44 and the second circuit board side 76, and/or between the second heat dissipater side 84 and the first heat sink side 88. The heat dissipater 40 has a thickness 92.

FIG. 4 depicts a plan view of the heat sink 64. The heat sink 64 has a plurality of heat sink holes 96 through the box-shaped structure 68 depicted in FIG. 3. In preferred embodiments the heat sink 64 is formed by injection molding and each of the holes 96 is formed at least in part through at least a portion of an injector mark that is an artifact of the injection molding process. In such embodiments the plurality of circuit board holes 30, the plurality of heat dissipater holes 52, and the plurality of heat sink holes 96 are aligned to form a plurality of air passages 98 through the circuit board 18, the heat dissipater 40, and the heat sink 64. The air passages 98 provide a convection flow of air to cool the illumination system 64.

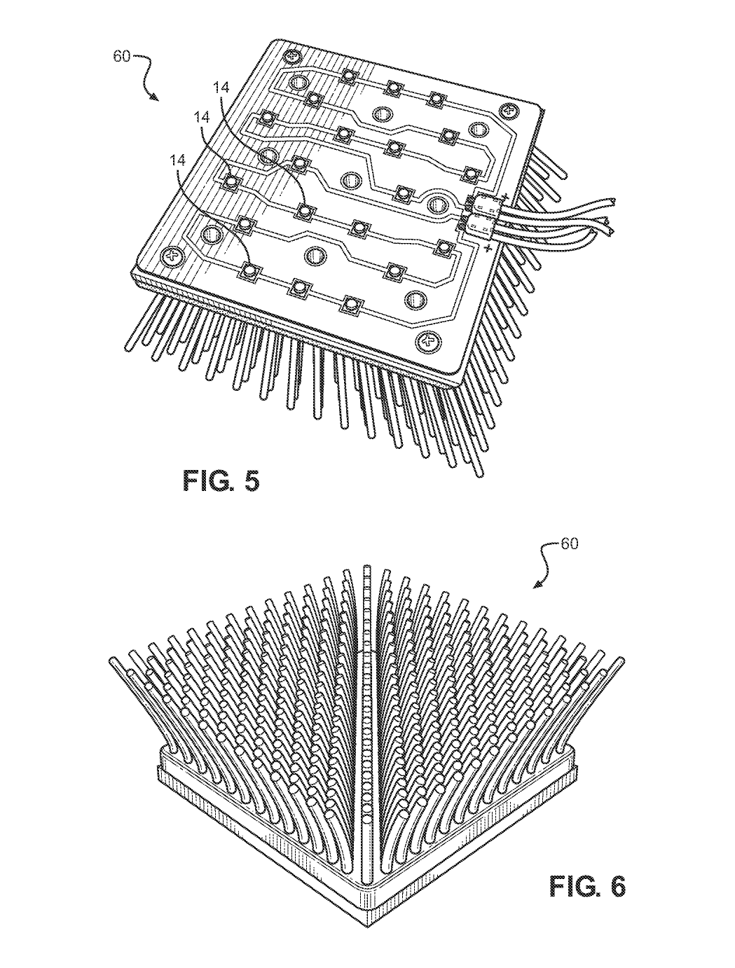

Typically the illumination system 10 and the illumination system 60 is installed with the LEDs (14) pointing downward. Thus, FIG. 5 is a perspective view of the illumination system 60 view from the bottom and FIG. 6 is a perspective view the illumination system viewed 64 from the top.

In operation of the illumination system 10 a heavy heat load may develop adjacent the LEDs 14. It is important to control the temperature at the solder point or the junction point of the LED. Keeping that temperature under control reduces mechanical stresses in the illumination systems, which reduce stress cracking, and which improves reliability of the system. It has been determined that the thickness 92 (shown in FIG. 3) of the thermal dissipater is an important determinant for providing adequate cooling of the illumination systems 10 and 60. Typically, when the LEDs 14 in the illumination system 10 and the illumination system 60 generate a minimum steady state thermal output that is in a range between 10 watt thermal and 100 watt thermal, with a typical valued being at least 50 watt-thermal. Typically the thermal conductivity between the first circuit board side 22 and the second heat dissipater side 84 is in a range from 0.1 watts per meter Kelvin to 5.0 watts per meter Kelvin, and is typically at least 0.3 watts per meter Kelvin. Under these operating parameters, in some embodiments, adequate cooling is established if the thermal gradient from a hottest temperature to a coolest temperature on the first circuit board side is in a range from 10 K/cm to 100 K/cm, and typically that thermal gradient is less than 50 K/cm. In some embodiments adequate cooling is established if the maximum thermal gradient between any two points on the first circuit board side is in a range from 10 K/cm to 500 K/cm, and typically that maximum thermal gradient is less than 100 K/cm. In some embodiments adequate cooling is established if a temperature measured in Kelvin at any first point adjoining the at least one light emitting diode is reduced by at a percentage of between 1% and 25%, but typically at least 10%, at second point opposite the first point on the second heat dissipater side. It is important that the performance of the heat dissipater be accomplished without a heat sink disposed adjacent the heat dissipater, or at least without a heat sink disposed adjacent the second heat dissipater side.

In summary, embodiments disclosed herein illuminations systems with improved mechanisms for dissipating the thermal energy generated by LEDs. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. An illumination system comprising:
a circuit board having an electrically conductive pattern and having a first circuit board side and an opposing second circuit board side;
at least one light emitting diode disposed on the first circuit board side wherein each light emitting diode is energized through the electrically conductive pattern and generates a minimum steady state thermal output of at least 50 watt-thermal; and
a heat dissipater having a first heat dissipater side and an opposing second heat dissipater side disposed adjacent the second circuit board side wherein the thermal conductivity between the first circuit board side and the first heat dissipater side is at least 0.3 watts per meter Kelvin,
wherein the heat dissipater has a sufficient thickness that at the maximum steady state thermal output of the at least one light emitting diode, without a heat sink disposed adjacent the second heat dissipater side, a thermal gradient from a hottest temperature to a coolest temperature on the first circuit board side is less than 50 K/cm.

2. The illumination system of claim 1 wherein:
the circuit board has at least one circuit board hole formed through the circuit board;
the heat dissipater has at least one heat dissipater hole formed through the heat dissipater; and
the illumination system further comprises an injection molded component having at least one injector mark and having at least one heat sink hole formed through the heat sink at least in part through at least a portion of the at least one injector mark wherein the at least circuit board hole, the at least one heat dissipater hole, and the at least one heat sink hole are aligned to form at least one air passage through the circuit board, the heat dissipater, and the heat sink.

3. An illumination system comprising:
a circuit board having an electrically conductive pattern and having a first circuit board side and an opposing second circuit board side;
at least one light emitting diode disposed on the first circuit board side wherein each light emitting diode is energized through the electrically conductive pattern and generates a minimum steady state thermal output of at least 50 watt-thermal; and
a heat dissipater having a first heat dissipater side and an opposing second heat dissipater side disposed adjacent the second circuit board side wherein the thermal conductivity between the first circuit board side and the first heat dissipater side is at least 0.3 watts per meter Kelvin,
wherein the heat dissipater has a sufficient thickness that at the maximum steady state thermal output of the at least one light emitting diode, without a heat sink disposed adjacent the second heat dissipater side, the maximum thermal gradient between any two points on the first circuit board side is less than 100 K/cm.

4. The illumination system of claim 3 wherein:
the circuit board has at least one circuit board hole formed through the circuit board;
the heat dissipater has at least one heat dissipater hole formed through the heat dissipater; and
the illumination system further comprises an injection molded component having at least one injector mark and having at least one heat sink hole formed through the heat sink at least in part through at least a portion of the at least one injector mark wherein the at least circuit board hole, the at least one heat dissipater hole, and the at least one heat sink hole are aligned to form at least one air passage through the circuit board, the heat dissipater, and the heat sink.

5. An illumination system comprising:
a circuit board having an electrically conductive pattern and having a first circuit board side and an opposing second circuit board side;
at least one light emitting diode disposed on the first circuit board side wherein each light emitting diode is energized through the electrically conductive pattern and generates a minimum steady state thermal output of at least 50 watt-thermal; and
a heat dissipater having a first heat dissipater side and an opposing second heat dissipater side disposed adjacent the second circuit board side wherein the thermal conductivity between the first circuit board side and the first heat dissipater side is at least 0.3 watts per meter Kelvin,
wherein the heat dissipater has a sufficient thickness that at the maximum steady state thermal output of the at least one light emitting diode, without a heat sink disposed adjacent the second heat dissipater side, a temperature measured in Kelvin at any first point adjoining the at least one light emitting diode is reduced by at least 10% at second point opposite the first point on the second heat dissipater side.

6. The illumination system of claim 5 wherein:
the circuit board has at least one circuit board hole formed through the circuit board;
the heat dissipater has at least one heat dissipater hole formed through the heat dissipater; and
the illumination system further comprises an injection molded component having at least one injector mark and having at least one heat sink hole formed through the heat sink at least in part through at least a portion of the at least one injector mark wherein the at least circuit board hole, the at least one heat dissipater hole, and the at least one heat sink hole are aligned to form at least one air passage through the circuit board, the heat dissipater, and the heat sink.
